(19) United States
(12) Patent Application Publication
(10) Pub. No.: US 2015/0096408 A1
(43) Pub. Date: Apr. 9, 2015

(54) Dual-Drive Hub Device

(71) Applicant: CHIN HAUR INDUSTRY CO., LTD., Kaohsiung City (TW)

(72) Inventor: King-Chen Lin, Kaohsiung City (TW)

(73) Assignee: CHIN HAUR INDUSTRY CO., LTD., Kaohsiung City (TW)

(21) Appl. No.: 14/107,092

(22) Filed: Dec. 16, 2013

(30) Foreign Application Priority Data
Oct. 8, 2013 (TW) 102136311

(51) Int. Cl. B62M 3/00

(52) U.S. Cl. CPC B62M 3/00
USPC 74/594.2

(57) ABSTRACT

A dual-drive hub device is mounted on a rear wheel of a bicycle and has a hub, a main shaft mounted through the hub, and two rear pedals connected to the main shaft. At least one one-way bearing is tightly fitted between the hub and the main shaft. A rear transmission wheel of a transmission system of the bicycle is mounted around the hub. When two front pedals of the bicycle are pedaled, the hub and the rear wheel rotate accordingly. When the rear pedals are pedaled, the main shaft, the hub and the rear wheel rotate accordingly. Thus, a rider and a passenger can pedal the front pedals and the rear pedals simultaneously and enjoy ease of bicycle pooling.

### BACKGROUND OF THE INVENTION

1. Field of the Invention

The present invention relates to a hub device, especially to a dual-drive hub device that is mounted on a rear wheel of a bicycle.

2. Description of the Prior Art(s)

A bicycle has a pedal assembly, a rear wheel, and a transmission system connecting the pedal assembly to the rear wheel. When a rider pedals, the pedal assembly drives the rear wheel to rotate via the transmission system, and the bicycle moves forward accordingly. The transmission system for the bicycle has a front transmission wheel and a conventional hub device. The front transmission wheel is connected to the pedal assembly. The conventional hub device, as disclosed in Taiwan Utility Model with Patent No. M374981, is mounted on the rear wheel of the bicycle, and has a rear transmission wheel and a flexible connecting element. The flexible connecting element is wrapped around the front transmission wheel and the rear transmission wheel. Thus, when the pedal assembly is pedaled, the pedal assembly sequentially drives the transmission system and the rear wheel to rotate, and the bicycle moves forward.

However, to keep the bicycle moving forward, the rider must keep on pedaling. Therefore, when under a poor road condition or on an uphill ride, or when a passenger is sitting on the bicycle, the rider has to pedal with extra labor. The passenger sitting behind the rider cannot assist the rider in pedaling, such that riding the bicycle requires a great effort. Consequently, interest and enjoyment for bicycle pooling is reduced.

Therefore, in order to improve the willingness for and enjoyment of bicycle pooling, a conventional trailer bicycle for two riders, as disclosed in Taiwan Utility Model with Patent No. M386228, is designed. The conventional trailer bicycle has an elongated frame, a front pedal assembly, a rear pedal assembly, a hub assembly mounted on a rear wheel of the trailer bicycle, a main transmission shaft mounted between the front pedal assembly and the rear pedal assembly, a first transmission assembly connecting the front pedal assembly to the main transmission shaft, a second transmission assembly connecting the rear pedal assembly to the main transmission shaft, and a third transmission assembly connecting the main transmission shaft to the hub assembly. Thus, when the front and the rear pedal assemblies are pedaled, the main transmission shaft is driven to rotate and then drives the rear wheel to rotate via the third transmission assembly and the hub assembly.

Although the above-mentioned trailer bicycle allows the two riders to share the enjoyment of bicycle pooling and to ride the trailer bicycle with ease, transmission structure of the trailer bicycle is complicated. Thus, the trailer bicycle costs higher than an ordinary bicycle. Moreover, the elongated frame of the trailer causes safety concerns such that the trailer bicycle can only be ridden on a road without heavy traffic. Consequently, use of the trailer bicycle is limited.

To overcome the shortcomings, the present invention provides a dual-drive hub device to mitigate or obviate the aforementioned problems.

### SUMMARY OF THE INVENTION

The main objective of the present invention is to provide a dual-drive hub device. The dual-drive hub device has a hub, a main shaft, at least one one-way bearing, two bearing sets, and two rear pedals. The hub has a mounting channel axially formed through the hub, two annular flanges disposed around an outer surface of the hub, two mounts respectively protruding from two opposite ends of the hub, and a fastening portion formed on an outer surface of one of the mounts. The main shaft is mounted through the mounting channel of the hub. The at least one one-way bearing is tightly fitted between the main shaft and the hub. The bearing sets are mounted on the main shaft. The rear pedals are respectively connected to the main shaft.

A rear transmission wheel of a transmission system of the bicycle is mounted around the hub. When two front pedals of the bicycle are pedaled, the hub and the rear wheel rotate accordingly. When the rear pedals are pedaled, the main shaft, the hub and the rear wheel rotate accordingly. Thus, a rider and a passenger can pedal the front pedals and the rear pedals simultaneously and enjoy ease of bicycle pooling.

Other objectives, advantages and novel features of the invention will become more apparent from the following detailed description when taken in conjunction with the accompanying drawings.

### BRIEF DESCRIPTION OF THE DRAWINGS

FIG. 1 is a side view of a dual-drive hub device in accordance with the present invention, showing the dual-drive hub device mounted on a rear wheel of a bicycle;

FIG. 2 is an exploded side view in partial section of the dual-drive hub device in FIG. 1;

FIG. 3 is a first operational side view of the dual-drive hub device in FIG. 1, showing the dual-drive hub device mounted on the rear wheel of the bicycle;

FIG. 4 is a first operational side view in partial section of the dual-drive hub device in FIG. 3;

FIG. 5 is a second operational side view of the dual-drive hub device in FIG. 1, showing the dual-drive hub device mounted on the rear wheel of the bicycle;

FIG. 6 is a second operational side view in partial section of the dual-drive hub device in FIG. 3;

FIG. 7 is a third operational side view of the dual-drive hub device in FIG. 1, showing the dual-drive hub device mounted on the rear wheel of the bicycle; and

FIG. 8 is a third operational side view in partial section of the dual-drive hub device in FIG. 3.

### DETAILED DESCRIPTION OF THE PREFERRED EMBODIMENTS

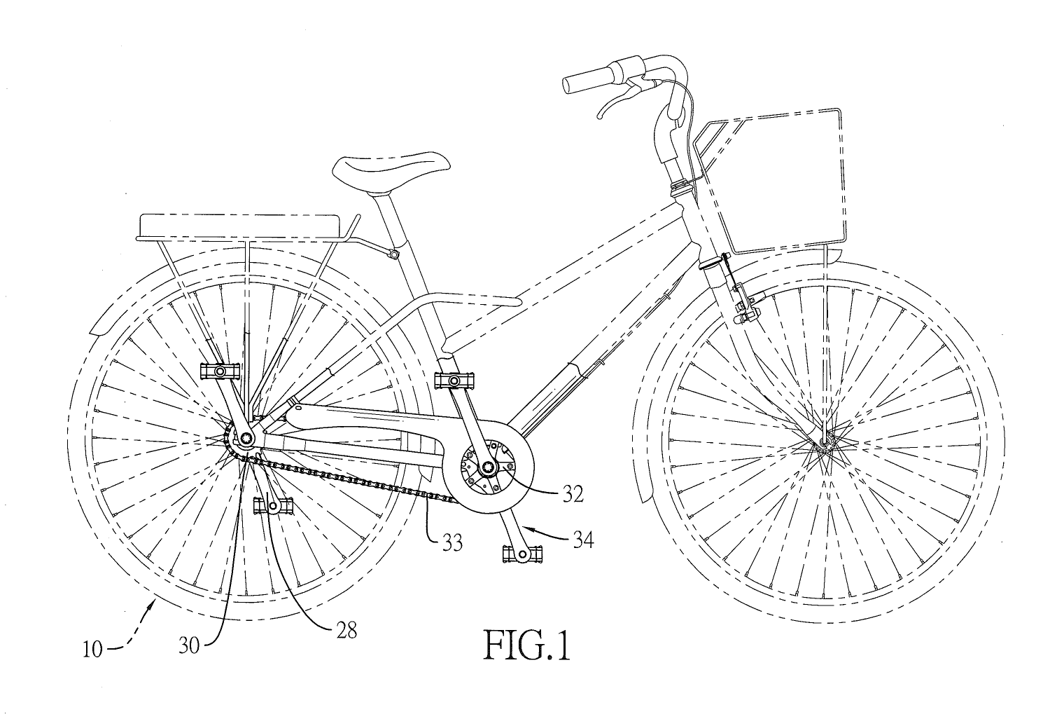

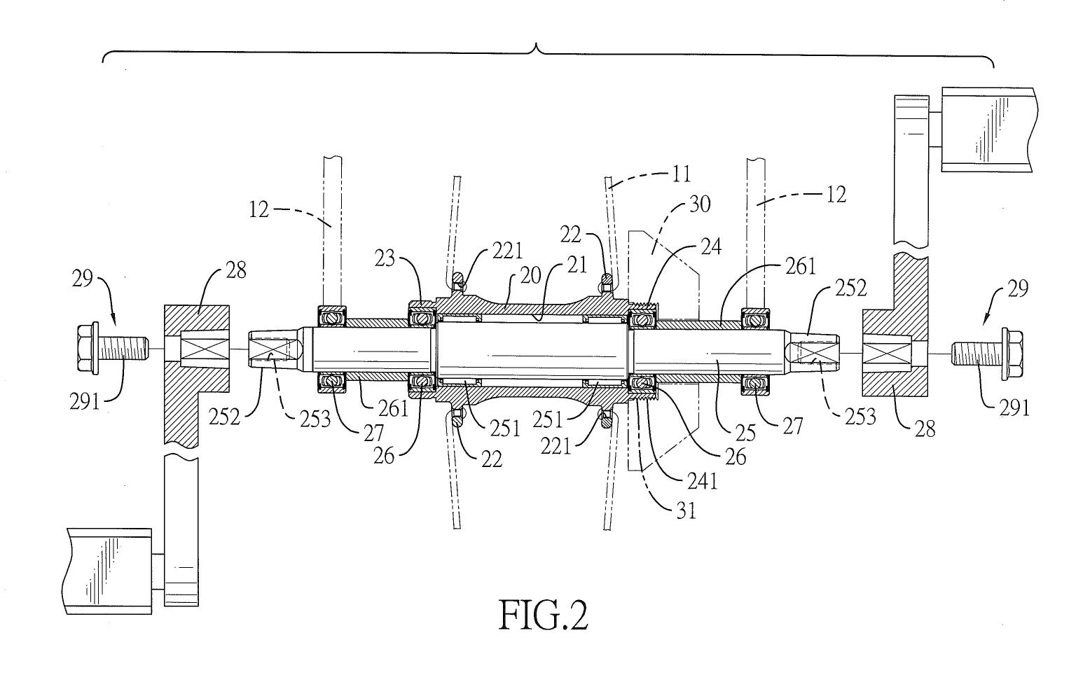

With reference to FIGS. 1 and 2, a dual-drive hub device in accordance with the present invention is mounted on a rear wheel 10 of a bicycle and comprises a hub 20, a main shaft 25, at least one one-way bearing 251, two bearing sets, two sleeves 261, and two rear pedals 28.

The hub 20 is mounted through a center of the rear wheel 10 of the bicycle and has two opposite ends, an outer surface, a mounting channel 21, two annular flanges 22, two mounts 23, 24, and a fastening portion 241.

The mounting channel 21 is formed in the hub 20 and axially extends through the ends of the hub 20. The annular flanges 22 are disposed around the outer surface of the hub 20 and are respectively disposed adjacent to the ends of the hub 20. Each of the annular flanges 22 has multiple through holes 221. The through holes 221 are formed through the annular flange 22 and are arranged around the outer surface of the hub 20. In the preferred embodiment, the annular flanges 22 of the hub 20 are integrally formed with the hub 20 as a single part. Alternatively, the annular flanges 22 may be securely mounted on the outer surface of the hub 20.

The rear wheel 10 of the bicycle has multiple spokes 11. Each of the spokes 11 has an inner end. The inner ends of the spokes 11 respectively hook in the through holes 221 of the annular flange 22 of the hub 20.

The mounts 23, 24 respectively protrude axially from the ends of the hub 20. Each of the mounts 23, 24 has an outer surface. The fastening portion 241 is formed on the outer surface of one of the mounts 23, 24.

The bicycle further has a transmission system. The transmission system has a rear transmission wheel 30 mounted around and securely attached to the fastening portion 241 of the hub 20, such that the rear transmission wheel 30 and the hub 20 rotate simultaneously. In the preferred embodiment, the rear transmission wheel 30 has a tapped hole 31, and the fastening portion 241 of the hub 20 is threaded so as to engage in the tapped hole 31 of the rear transmission wheel 30. Thus, the rear transmission wheel 30 and the hub 20 rotate simultaneously. Alternatively, the rear transmission wheel 30 may be securely attached to the hub 20 via at least one pin.

The main shaft 25 is mounted through the mounting channel 21 of the hub 20 and has two fastening ends 252. The fastening ends 252 of the main shaft 25 are oppositely disposed and respectively protrude out of the mounting channel 21 from the ends of the hub 20. Each of the fastening ends 252 is non-circular in cross-section.

The at least one one-way bearing 251 is securely mounted around the main shaft 25, and is disposed and tightly fitted between the main shaft 25 and the hub 20. Each of the at least one one-way bearing 251 may be a one-way roller bearing or a one-way ball bearing. In the preferred embodiment, the dual-drive hub device has two one-way bearings 251 respectively corresponding in position to the annular flanges 22 of the hub 20.

When the main shaft 25 rotates in a forward direction, the main shaft 25 drives the hub 20 to rotate simultaneously via the at least one one-way bearing 251. When the main shaft 25 rotates in a backward direction or stops rotating, the hub 20 is freed from being driven by the main shaft 25 and the at least one one-way bearing 251.

The bearing sets are mounted on the main shaft 25 and are respectively disposed adjacent to the fastening ends 252 of the main shaft 25. Each of the bearing sets has a proximal bearing 26 and a distal bearing 27. The proximal bearing 26 is securely mounted around the main shaft 25, and is disposed and tightly fitted between the main shaft 25 and a corresponding one of the mounts 23, 24. Thus, the proximal bearings 26 of the bearing sets support the main shaft 25, such that the main shaft 25 is kept coaxial with the hub 20. The distal bearing 27 is securely mounted around the main shaft 25, and is disposed between the proximal bearing 26 and an adjacent one of the fastening ends 252 of the main shaft 25.

The bicycle further has a rear fork 12 securely connected to the distal bearings 27 of the bearing sets.

The sleeves 261 are mounted around the main shaft 25. Each of the sleeves 261 is disposed between the proximal bearing 26 and the distal bearing 27 of a corresponding one of the bearing sets. The sleeve 261 keeps the proximal bearing 26 and the distal bearing 27 separated by a specific distance.

The rear pedals 28 are respectively and securely connected to the fastening ends 252 of the main shaft 25. Each of the rear pedals 28 is held on the fastening end 252 of the main shaft 25 via a positioning element 29. In the preferred embodiment, each of the fastening ends 252 of the main shaft 25 has an end surface and a tapped hole 253 formed in the end surface. Each of the positioning elements 29 is a bolt 291. The two bolts 291 are respectively mounted through the rear pedals 28 and are respectively threaded into the tapped holes 253 of the main shaft 25. Thus, when the rear pedals 28 are pedaled, the main shaft 25 rotates accordingly.

As shown in FIG. 1, the dual-drive hub device as described is mounted on the rear wheel 10 of the bicycle. The transmission system of the bicycle further has a front transmission wheel 32 and a flexible connecting element 33. The flexible connecting element 33 is wrapped around the front transmission wheel 32 and the rear transmission wheel 30. The flexible connecting element 33 may be a chain while the front transmission wheel 32 and the rear transmission wheel 30 may be sprockets. Alternatively, the flexible connecting element 33 may be a belt while the front transmission wheel 32 and the rear transmission wheel 30 may be friction wheels with high coefficient of friction.

Furthermore, the bicycle further has two front pedals 34 that can drive the front transmission wheel 32 to rotate. When the front pedals 34 are pedaled to rotate forwardly, the front transmission wheel 32 rotates accordingly. When the front pedals 34 are not pedaled or are pedaled to rotate backwardly, the front transmission wheel 32 is freed from being driven by the front pedals 34.

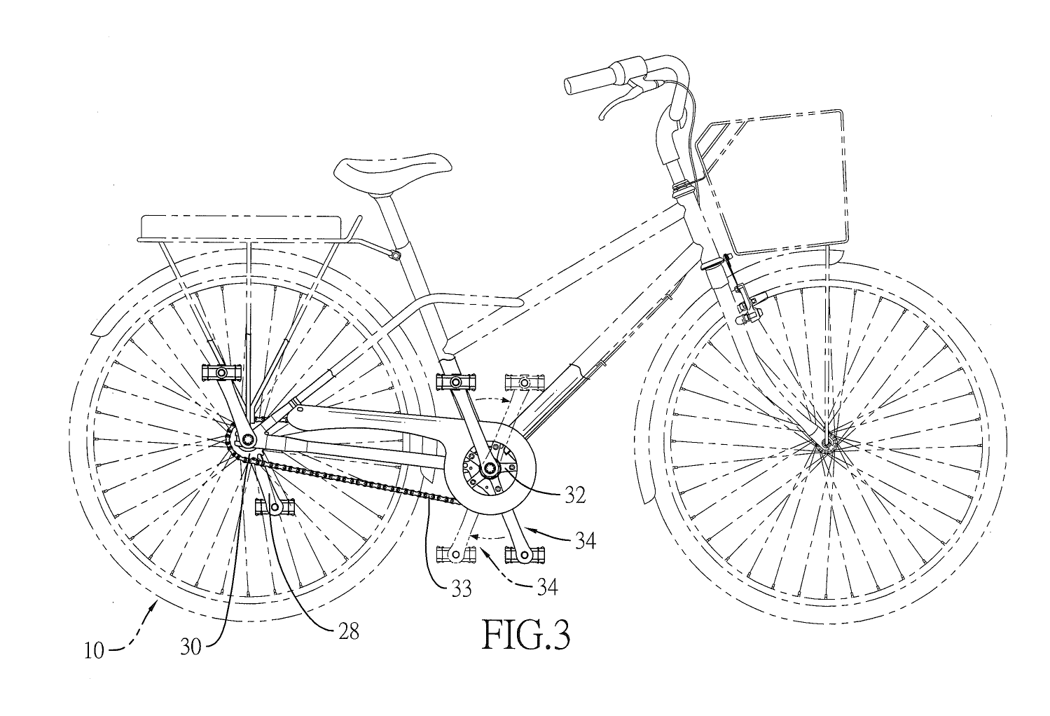

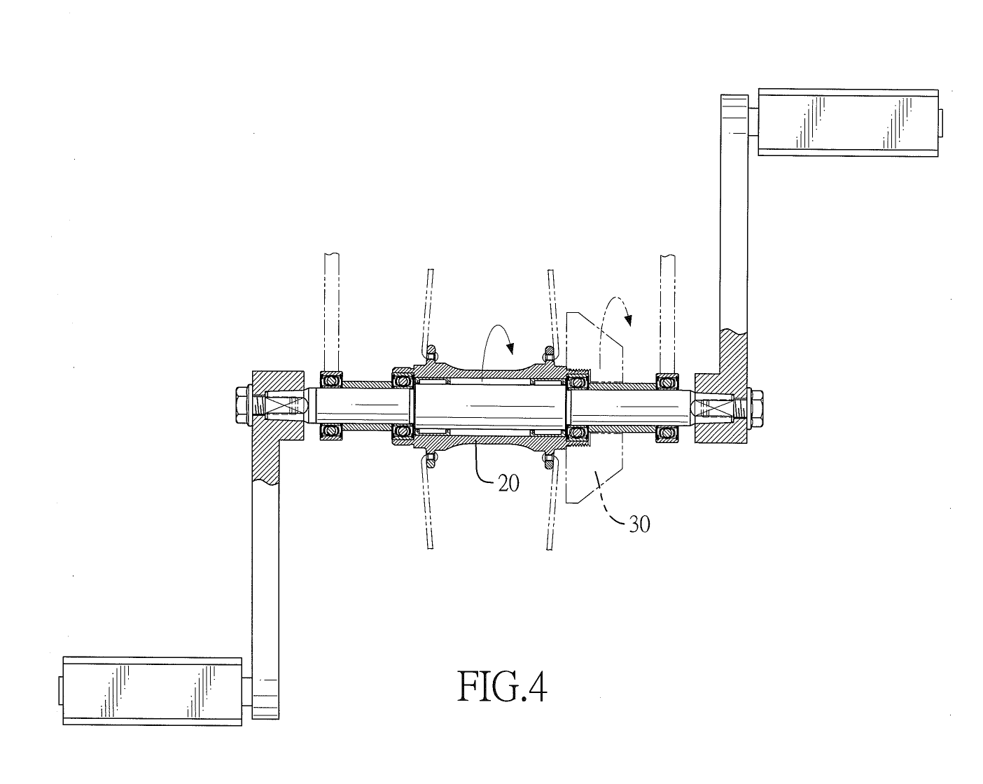

With further reference to FIGS. 3 and 4, when the front pedals 34 are pedaled to rotate forward, the front transmission wheel 32, the flexible connecting element 33, and the rear transmission wheel 30 rotate forward accordingly. Since the rear transmission wheel 30 is securely attached to the hub 20, the hub 20 rotates along with the rear transmission wheel 30 so as to drive the bicycle to move forward.

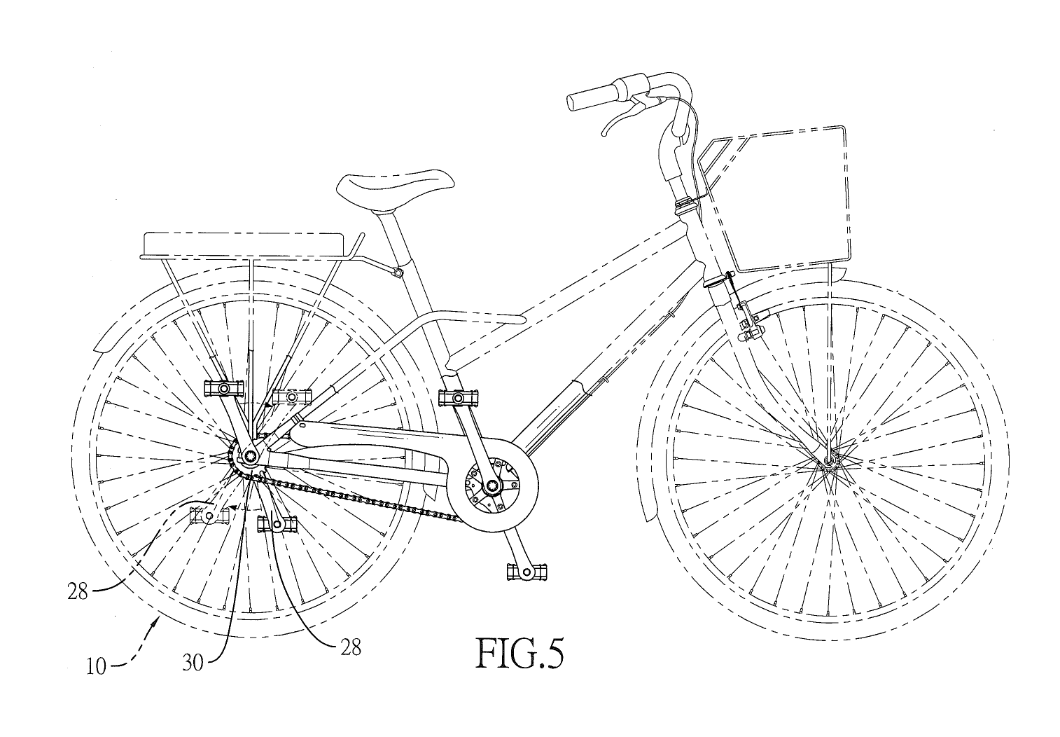

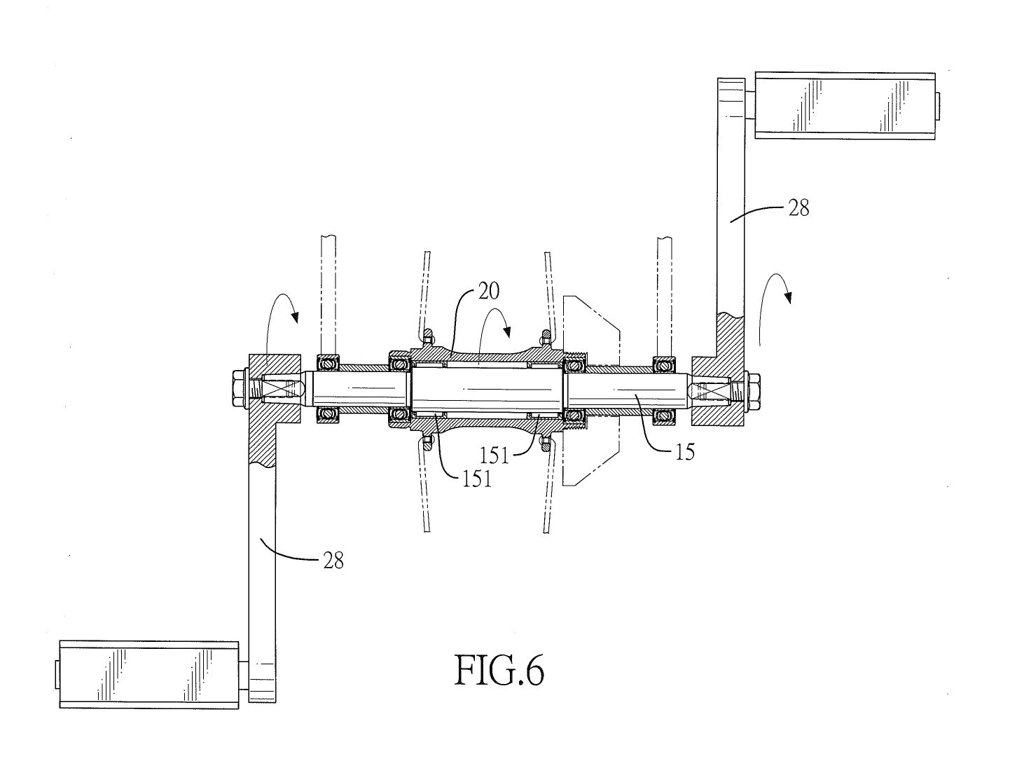

With further reference to FIGS. 5 and 6, when the rear pedals 28 are pedaled to rotate forward, the main shaft 25 that is securely connected with the rear pedals 28 is driven to rotate forward. Then the main shaft 25 drives the hub 20 and the rear wheel 10 to rotate simultaneously via the at least one one-way bearing 251.

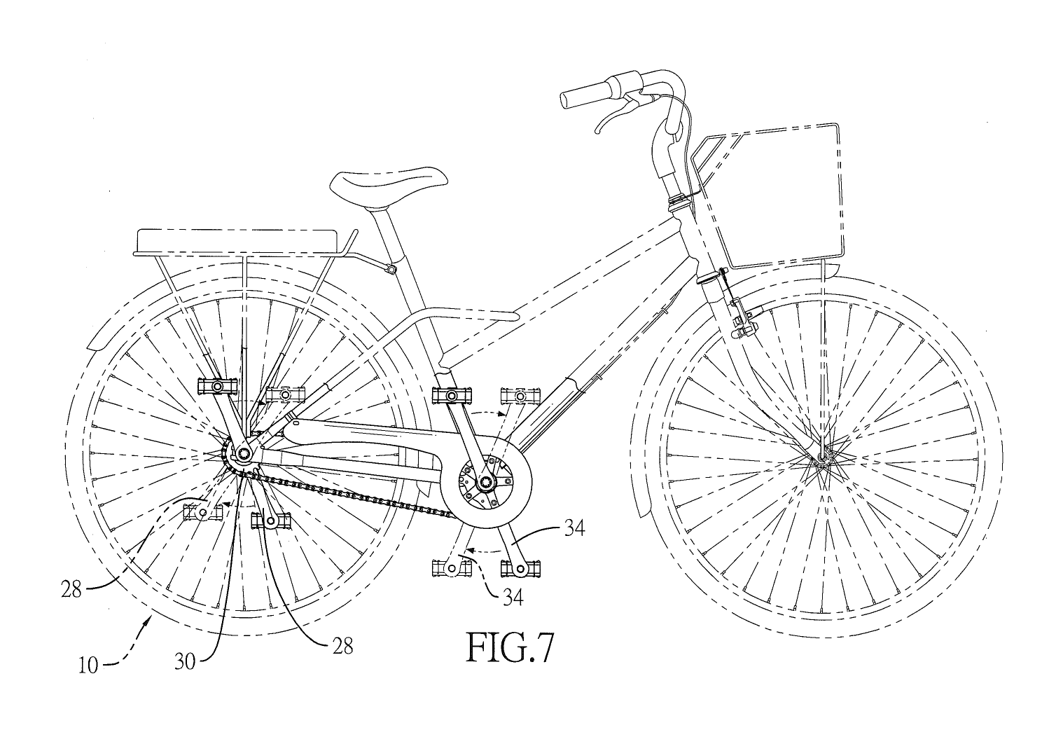

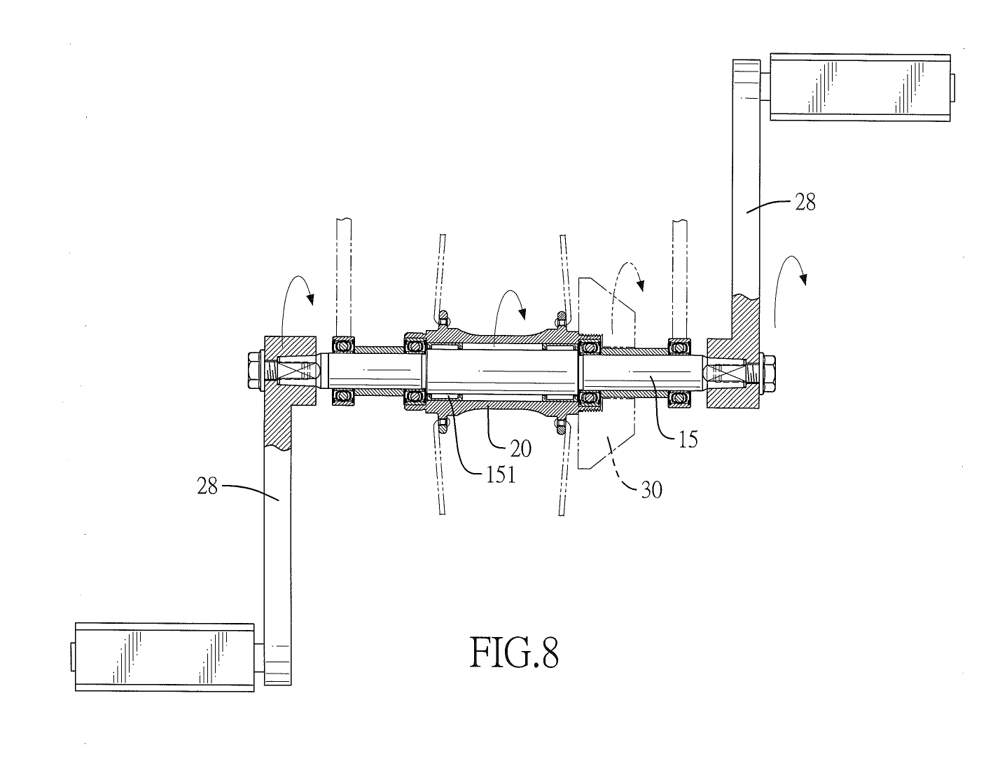

With further reference to FIGS. 7 and 8, since the dual-drive hub device is mounted on the rear wheel 10, a rider can pedal the front pedals 34 and a passenger can pedal the rear pedals 28 so as to ride the bicycle to move forward. As the rider and the passenger pedal the front pedals 34 and the rear pedals 28 at the same time, the hub 20 is driven to rotate by two input powers. Therefore, each of the rider and the passenger can ride the bicycle in an effort-saving way.

The dual-drive hub device for the bicycle as described has the following advantages. With mounting the dual-drive hub device on the rear wheel 10 of the bicycle, two people, i.e. the rider and the passenger, can simultaneously pedal to enjoy ease of bicycle pooling. Furthermore, the transmission system of the bicycle does not have to be rearranged and a frame of the bicycle is not elongated. Thus, the bicycle that is refitted with the dual-drive hub device costs low and is safe for use.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A dual-drive hub device comprising:
a hub having
a mounting channel formed in the hub and axially extending through two opposite ends of the hub;
two annular flanges disposed around an outer surface of the hub and respectively disposed adjacent to the ends of the hub, and each of the annular flanges having multiple through holes formed through the annular flange and arranged around the outer surface of the hub;
two mounts respectively protruding axially from the ends of the hub; and
a fastening portion formed on an outer surface of one of the mounts;
a main shaft mounted through the mounting channel of the hub and having two fastening ends respectively protruding out of the mounting channel from the ends of the hub;
at least one one-way bearing securely mounted around the main shaft, and disposed and tightly fitted between the main shaft and the hub;
two bearing sets mounted on the main shaft and respectively disposed adjacent to the fastening ends of the main shaft; and
two rear pedals respectively and securely connected to the fastening ends of the main shaft.

2. The dual-drive hub device as claimed in claim 1, wherein the annular flanges of the hub are integrally formed with the hub as a single part.

3. The dual-drive hub device as claimed in claim 1, wherein the annular flanges of the hub are securely mounted on the outer surface of the hub.

4. The dual-drive hub device as claimed in claim 1, wherein the fastening portion of the hub is threaded.

5. The dual-drive hub device as claimed in claim 2, wherein the fastening portion of the hub is threaded.

6. The dual-drive hub device as claimed in claim 3, wherein the fastening portion of the hub is threaded.

7. The dual-drive hub device as claimed in claim 1, wherein each of the rear pedals is held on the fastening end of the main shaft via a positioning element.

8. The dual-drive hub device as claimed in claim 2, wherein each of the rear pedals is held on the fastening end of the main shaft via a positioning element.

9. The dual-drive hub device as claimed in claim 3, wherein each of the rear pedals is held on the fastening end of the main shaft via a positioning element.

10. The dual-drive hub device as claimed in claim 4, wherein each of the rear pedals is held on the fastening end of the main shaft via a positioning element.

11. The dual-drive hub device as claimed in claim 5, wherein each of the rear pedals is held on the fastening end of the main shaft via a positioning element.

12. The dual-drive hub device as claimed in claim 6, wherein each of the rear pedals is held on the fastening end of the main shaft via a positioning element.

13. The dual-drive hub device as claimed in claim 7, wherein
each of the fastening ends of the main shaft has
an end surface; and
a tapped hole formed in the end surface; and
each of the positioning elements is a bolt, and the two bolts are respectively mounted through the rear pedals and are respectively threaded into the tapped holes of the main shaft.

14. The dual-drive hub device as claimed in claim 8, wherein
each of the fastening ends of the main shaft has
an end surface; and
a tapped hole formed in the end surface; and
each of the positioning elements is a bolt, and the two bolts are respectively mounted through the rear pedals and are respectively threaded into the tapped holes of the main shaft.

15. The dual-drive hub device as claimed in claim 9, wherein
each of the fastening ends of the main shaft has
an end surface; and
a tapped hole formed in the end surface; and
each of the positioning elements is a bolt, and the two bolts are respectively mounted through the rear pedals and are respectively threaded into the tapped holes of the main shaft.

16. The dual-drive hub device as claimed in claim 10, wherein
each of the fastening ends of the main shaft has
an end surface; and
a tapped hole formed in the end surface; and
each of the positioning elements is a bolt, and the two bolts are respectively mounted through the rear pedals and are respectively threaded into the tapped holes of the main shaft.

17. The dual-drive hub device as claimed in claim 11, wherein
each of the fastening ends of the main shaft has
an end surface; and
a tapped hole formed in the end surface; and
each of the positioning elements is a bolt, and the two bolts are respectively mounted through the rear pedals and are respectively threaded into the tapped holes of the main shaft.

18. The dual-drive hub device as claimed in claim 12, wherein
each of the fastening ends of the main shaft has
an end surface; and
a tapped hole formed in the end surface; and
each of the positioning elements is a bolt, and the two bolts are respectively mounted through the rear pedals and are respectively threaded into the tapped holes of the main shaft.
